(19) United States
(12) Patent Application Publication
(10) Pub. No.: US 2010/0002020 A1
(43) Pub. Date: Jan. 7, 2010

(54) IN-PLANE SWITCHING ELECTROPHORETIC DISPLAY DEVICE

(75) Inventors: Sander Jurgen Roosendaal, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/438,740

(22) PCT Filed: Aug. 27, 2007
(86) PCT No.: PCT/IB2007/053406

§ 371 Date: Feb. 25, 2009

(30) Foreign Application Priority Data
Aug. 30, 2006 (EP) 06119823.0

(51) Int. Cl. G06F 3/038; G02F 1/167

(52) U.S. Cl. 345/690; 359/296; 345/107

(57) ABSTRACT

A display device comprising a plurality of pixels (200), each pixel comprising charged particles (28) that are movable between storage (20) and active (24) regions of the pixel under the influence of an electric field. The number of charged particles (28) within the active region (24) determines the optical appearance of the pixel, and the storage region (20) is used for storing charged particles (28) away from the active region (24). Each pixel (200) comprises enough charged particles to saturate both the storage and active regions, such that moving additional charged particles to those regions does not significantly affect the optical appearances of those regions. Hence there are always enough charged particles (28) available within the pixel (200) to saturate the active region (24), and the storage region (20) may be saturated even when the active region (24) is saturated.

This invention relates to moving particle display devices, and in particular to in-plane electrophoretic display devices.

Moving particle display devices, such as electrophoretic displays, have been known for many years, and are based on the principle that charged particles and especially charged pigmented or dyed particles may be moved around under the influence of electric fields to alter the optical appearance of the display. For example, U.S. Pat. No. 3,612,758 describes an electrophoretic display where the appearance of an electrophoretic material is controllable by means of electric fields.

To this end, the electrophoretic medium typically comprises electrically charged particles having a first optical appearance (e.g. black) contained in a fluid such as liquid or air having a second optical appearance (e.g. white), the first optical appearance being different from the second optical appearance. The display typically comprises a plurality of pixels, each pixel being separately controllable by means of separate electric fields supplied by electrode arrangements. The particles are thus movable by means of an electric field between visible regions, invisible regions, and possibly also intermediate semi-visible regions. Thereby the appearance of the display is controllable.

The distance that a particle moves through an electrophoretic medium is roughly proportional to the integral of the applied electric field with respect to time. Hence the greater the electric field strength, and the longer the electric field is applied for, the further the particles will move.

So called “In-plane” electrophoretic pixels use electric fields that are lateral to the display substrate to move particles from a storage region hidden from the viewer to an active region. The larger the number of particles that are moved to or from the active region, the greater the change in the optical appearance of the pixel. Applicant's International Application WO2004/008238 gives an example of a typical in-plane electrophoretic display. In-plane electrophoretic pixels may be used to form reflective, transflective or transmissive displays.

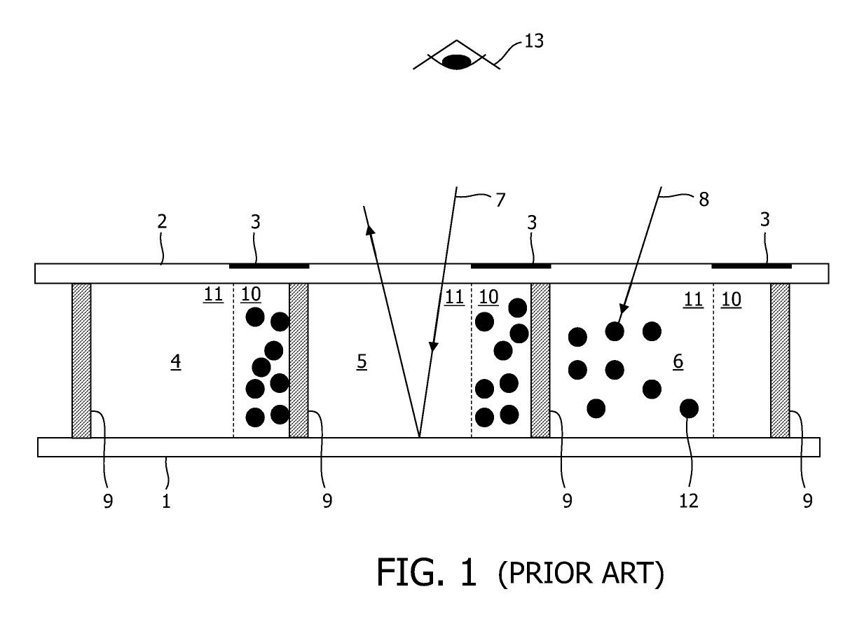

FIG. 1 shows a cross-sectional view of a known in-plane electrophoretic display comprising three pixels 4, 5, and 6. The pixels are disposed over a reflective substrate 1, and a partly transparent substrate 2 is disposed over the pixels. The pixels are separated apart from one another by a plurality of partition walls 9. The substrate 2 is transparent over all areas except for those areas that are coated with black masking 3. Each pixel comprises a storage region 10 which is hidden from the view of viewer 13 by the black masking 3, and an active region 11 which is viewable by the viewer 13 through the transparent substrate 2. The pixels are filled with an electrophoretic fluid comprising charged particles 12, and the charged particles are movable between the storage and active regions to control the optical appearances of the pixels. For example, all of the charged particles 12 of pixel 5 have been moved to the storage area 10 beneath the black masking 3, and so an incident ray of light 7 passes through the electrophoretic fluid and is reflected back to the viewer. In contrast, all of the charged particles 12 of pixel 6 have been moved into the active area 11, and so an incident ray of light 8 is absorbed by a charged particle 12 and not reflected back to the viewer 13. Hence, the optical appearance of each pixel may be controlled by altering the number and distribution of charged particles within the active area 11.

The contrast of the display 14 is the difference between the brightest and darkest optical appearances that can be displayed by each pixel. Hence, to maximize the contrast of the display, the darkest optical appearance should be very dark and the brightest optical appearance should be very bright.

To enable a very dark appearance (when the light-absorbing particles 12 are within the active region 11), it is necessary that the black mask 3 should be made as dark as possible, so the black mask does not reflect any light back to the viewer 13.

To enable a very bright appearance, (when the light-absorbing particles 12 are within the storage region 10), it is necessary that the black mask 3 is sized and aligned very accurately with respect to the storage region 10, so that no larger a portion of the pixel than necessary will absorb light. For example, if the black mask 3 un-intentionally covers some of the active region of a pixel, then the brightness of the pixel is reduced.

Some of the problems associated with forming a high contrast in-plane display are the difficulties of manufacturing a black mask that is highly light absorbing, that is of the correct size, and that is accurately aligned with the storage regions of the pixels.

Another problem associated with electrophoretic displays, is the difficulty of evenly filling every pixel so that each pixel has the same number of charged particles. Pixels that have a lower number of charged particles may not be able to display as dark an optical appearance as pixels having a higher number of charged particles.

It is therefore an object of the invention to improve upon the known art.

According to a first aspect of the invention, there is provided a display device comprising a plurality of pixels, each pixel comprising:

movable charged particles;

an active region, the number of charged particles that are moved into the active region determining the optical appearance of the pixel;

a storage region for storing charged particles away from the active region; and wherein the charged particles are movable between the storage and active regions under the influence of an electric field; and wherein each pixel comprises a sufficient number of charged particles to simultaneously saturate both the storage and active regions.

The optical appearance of a region of a pixel is typically not a linear function of the number of charged particles that are within the region. Typically, the more charged particles that are within a region, the less of an impact moving additional charged particles to the region has on the optical appearance of the region.

A region of a pixel is considered to be saturated when there are so many charged particles within the region, that adding more of the charged particles to the region would not have an appreciable effect on the optical appearance of the region as viewed by a viewer.

Since each pixel comprises a sufficient number of charged particles to simultaneously saturate both the storage and active regions, a sufficient number of charged particles to saturate the storage region will always be available, even if the active region is required to be saturated as well.

Hence, the requirements for the black mask over the storage region are greatly reduced, since a number of charged particles can always remain in the storage region, and those charged particles that remain in the storage region can at least partially perform the function of the black mask.

Therefore, the black mask may be made less dense (less absorbing to light) due to the charged particles beneath it, which may simplify the creation of the black mask.

Furthermore, the exact size and placement of the black mask may become less critical, since the effect of the black mask intruding into an active area of a pixel is likely to be less severe when the black mask is less dense.

Alternatively, the black mask over the storage region may be removed completely, greatly simplifying and reducing the cost of the manufacturing process. Hence the storage region may be viewable by a viewer.

Advantageously, filling the pixels with so many charged particles that both the storage and active regions can be saturated simultaneously, means that there are always enough charged particles to saturate at least the active region, and so uneven pixel filling becomes much less of a problem.

Each pixel may comprise a storage electrode associated with the storage region, and a viewing electrode associated with the active region. Then the storage and viewing electrodes may be driven with control signals to set up electric fields for controlling the movements of the charged particles. The pixel may also comprise an additional electrode associated with the active region, the additional electrode drivable with control signals to improve the distribution of charged particles over the active region.

Furthermore, each pixel may comprise a gate electrode associated with a gate region between the storage and active regions, and the charged particles may move between the storage and active regions via the gate region. Hence, the gate electrode associated with the gate region may be used to control the numbers of charged particles that are moved between the storage and active regions.

Additionally, the plurality of pixels may be arranged in an array of rows and columns of pixels, each row of pixels associated with a respective row electrode that is connected to or forms portions of the gate electrodes of the pixels of the row, and each column of pixels associated with a respective column electrode that is connected to or forms portions of the viewing electrodes of the pixels of the column.

The row electrodes may be used to select a row of pixels to be addressed, and the column electrodes may be used to simultaneously apply data to all of the pixels of the selected row. Hence, the row and column electrodes may be used to set the optical appearances of each of the plurality of pixels.

The plurality of pixels may be disposed between first and second substrates, and the charged particles may be moved laterally of the substrates between the storage and active regions of each pixel. The second substrate may be transparent over both the storage and active regions of each pixel, such that the storage and active regions are viewable (visible) by a viewer (i.e. there is no black mask over the storage region for obstructing the storage region from the view of the viewer). Hence, the costs and complexity of forming a black mask over the storage region are removed.

Additionally, the second substrate may be transparent over the gate regions of each pixel, such that the gate regions are viewable by a viewer (i.e. there is no black mask aligned over the gate region for obstructing the gate region from the view of the viewer).

Furthermore, the second substrate may be made transparent over the whole of the area of the pixel, including over any regions in addition to the storage regions, for example over any active circuitry regions. The regions of the second substrate that are outside of the pixel areas, for example regions that are above any partition walls existing between the pixels, may or may not be transparent.

According to a second aspect of the invention, there is provided a method for driving a display device, the display device comprising at least first and second pixels, each pixel comprising:

movable charged particles;

an active region, the number of charged particles that are moved into the active region determining the optical appearance of the pixel;

a storage region for storing charged particles away from the active region; and wherein the charged particles are movable between the storage and active regions under the influence of an electric field; and wherein each pixel comprises a sufficient number of charged particles to simultaneously saturate both the storage and active regions, the method comprising:

attracting all of the charged particles of the first pixel to the storage region of the first pixel, thereby saturating the storage region of the first pixel;

attracting a first number of charged particles from the storage region of the first pixel to the active region of the first pixel; and

wherein the first number of charged particles is high enough to saturate the active region, but not so high that the storage region loses saturation.

Hence, there is provided a drive method that always enables enough charged particles to remain in the storage regions to at least partially perform the function of a black mask. Hence, the requirements for the black mask are greatly reduced. Furthermore, un-even pixel filling becomes much less of a problem since there are always enough charged particles available to saturate at least the active regions of each pixel.

Additionally, a second pixel may be driven to move all of its charged particles into its active region, de-saturating its storage region. Hence, in the case where the storage region is viewable by a viewer (i.e. not obscured by a black mask), the optical appearance of the storage region is controllable, and this controllability may be used to give reproducible grey levels or to effectively increase the resolution of the pixel. If one of the active and storage regions of a pixel is saturated, then the optical appearance of the other of the storage and active regions of the pixel may be controlled.

Furthermore, the pixels may be driven to generate intermediate optical states (e.g. grey levels) by moving higher or lower numbers of charged particles into the active regions of the pixels. The distances that the charged particles move are proportional to the time and intensity of the applied electric fields, and so the numbers of charged particles that are moved between the storage and active regions of each pixel can be controlled by controlling the time and strength of the applied electric fields.

Embodiments of the invention will now be described, by way of example only, and with reference to the accompanying drawings, in which:

FIG. 1 shows a cross-sectional schematic diagram of a known in-plane electrophoretic pixel;

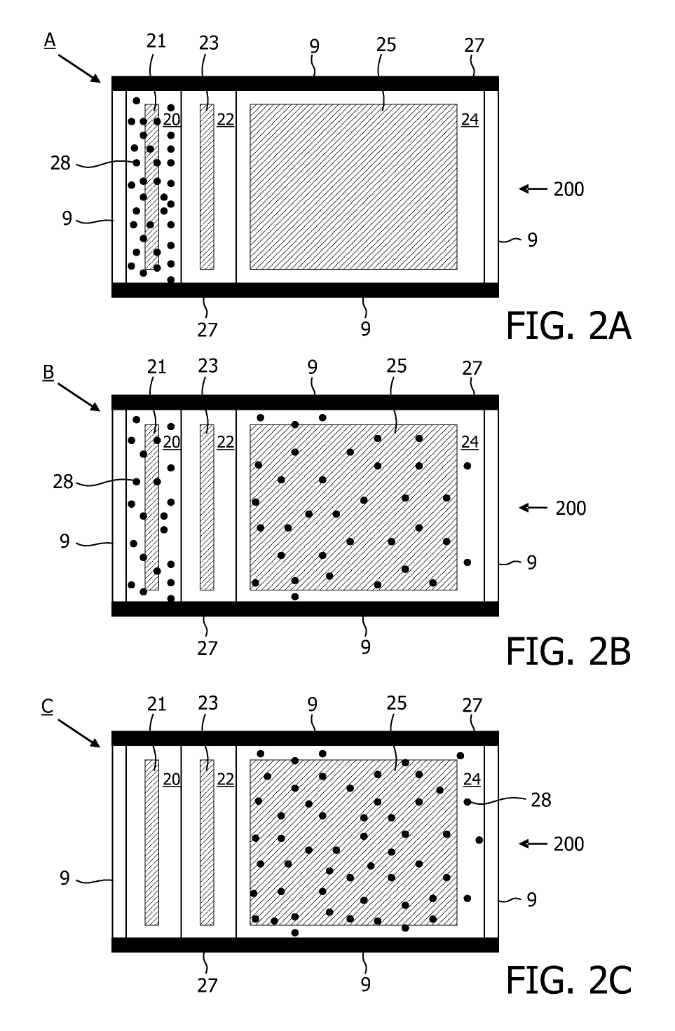

FIGS. 2A-2C show plan schematic diagrams of an electrophoretic pixel according to an embodiment of the invention;

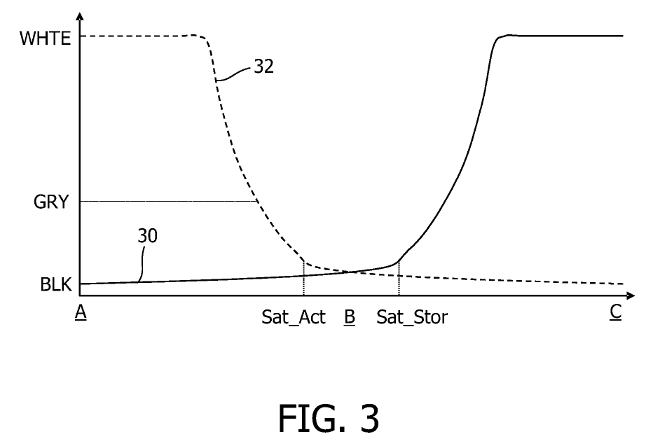

FIG. 3 shows a graph of the optical appearances of the storage and active regions of the pixel of FIGS. 2A-2C; and

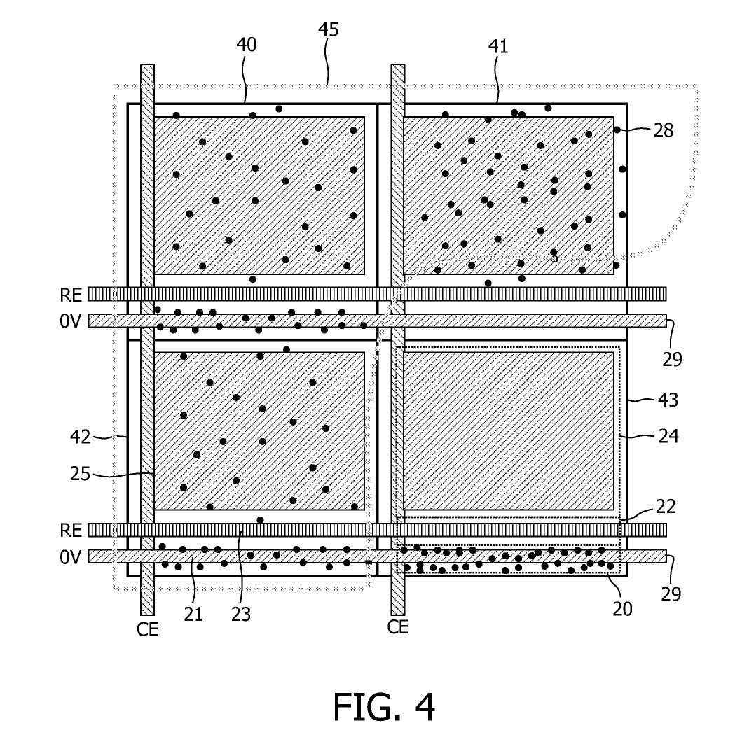

FIG. 4 shows a plan schematic diagram of an array of the electrophoretic pixels of FIGS. 2A-2C.

The figures are not drawn to scale, and same or similar reference signs are used to denote same or similar features.

An embodiment of the invention is now described with reference to FIGS. 2A-2C. FIGS. 2A, 2B, and 2C show plan schematic diagrams of an electrophoretic pixel 200 that has a storage region 20, a gate region 22, and an active region 24. The storage region 20 is associated with a storage electrode 21, the gate region 22 associated with a gate electrode 23, and the active region 24 associated with a viewing electrode 25.

The pixel 200 is filled with an electrophoretic fluid comprising movable charged black particles 28. The charged black particles 28 are positively charged, and hence move in the same direction as electric field lines of force, as will be apparent to those skilled in the art.

The storage, gate, and viewing electrodes 21, 23, and 25, are used to generate electric fields to move the charged black particles 28 between the storage and active regions 20 and 24 of the pixel 200 via the gate region 22. The pixel 200 comprises black masking 27 that hides two of the four pixel walls 9 that enclose the electrophoretic fluid. There is no black masking over the storage, or the gate, or of course the active regions, such that the storage, gate and active regions are all viewable by a viewer. Hence, the optical appearance of the storage, gate, and viewing regions depends on the number of charged black particles 28 within them.

FIG. 2A shows a situation A where all of the charged black particles 28 are within the storage region 20. Light incident on the storage region 20 is absorbed by the charged black particles, and light incident on the active region 24 is reflected back to the viewer from a white reflector (not shown for clarity) beneath the active region. Hence, the pixel has an optical appearance of white. The white reflector may be formed by the substrate beneath the pixel, or it may be formed by a layer between the substrate and the active region, or it may simply be formed by the viewing electrode. Clearly, the viewing electrode 25 must be transparent if the white reflector is placed on the opposite side of the viewing electrode from the active area.

To provide the state shown in FIG. 2A, the storage electrode 21 is set at a voltage of 0V, the gate electrode 23 is set at a voltage of +10V, and the viewing electrode 25 is set at a voltage of +15V, thereby setting up an electric field that attracts the charged black particles 28 to the storage region 20. After the charged black particles have been moved to the storage region 20, the viewing electrode is set to 0V, with the charged black particles being held within the storage region due to the electric field between the gate and storage electrodes 21 and 23.

FIG. 2B shows a situation B (following situation A) where a first number of charged black particles 28 have been attracted from the storage region 20 to the active region 24. To provide situation B, the voltage of the gate electrode 23 is lowered to 0V, and the voltage of the viewing electrode 25 is lowered to −5V, for a period of time sufficient for the first number of charged black particles to move from the storage region to the active region. Then, the voltage of the gate electrode 23 is raised back up to +10V and the voltage of the viewing electrode 25 is raised back up to 0V.

The charged black particles naturally diffuse to substantially evenly distribute themselves over the active region 24, although alternatively an additional electrode may be associated with the active region 24 to speed the distribution of the charged black particles.

The first number of charged black particles 28 is just large enough to saturate the active region 24, giving the pixel 200 a black optical appearance. There are still enough charged black particles 28 within the storage region 20 so that the storage region is still saturated and still has an optical appearance of black. Hence, there is no need for a black mask to cover the storage region 20, and there are always enough charged black particles 28 within the pixel to saturate the active region, even if the pixel has less charged black particles than it should due to un-even pixel filling.

FIG. 2C shows a situation C (also following situation A) where a second number of charged black particles 28 have been attracted from the storage region 20 to the active region 24. To provide situation C, the voltage of the gate electrode 23 is lowered to 0V and the voltage of the viewing electrode 25 is lowered to −5V, for a period of time sufficient for the second number of charged black particles to move from the storage region to the active region. Then, the voltage of the gate electrode 23 is raised back up to +10V and the voltage of the viewing electrode 25 is raised back up to 0V.

The second number of charged black particles 28 is more than large enough to saturate the active region 24, giving the pixel 200 a black optical appearance. The second number of charged black particles 28 is so large that the storage region 20 becomes de-saturated, and has a white optical appearance since a white reflector (not shown for clarity) beneath the storage area is now visible. The white reflector beneath the storage region is formed in the same manner as the white reflector beneath the active region, as discussed above in relation to FIG. 2A.

The absolute numbers for the first and second numbers of particles will depend on the relative areas and volumes of the storage and active regions, and on the absorption characteristics of the charged black particles 28, as will be apparent to those skilled in the art.

As it is sometimes difficult to accurately and reproducibly switch pixel to brightness values intermediate between white and black (known as grey levels or color tints), known display pixels are often switched to black if they need to represent a grey level that is closer to black than white, or switched to white if they need to represent a grey level that is closer to white than black. However, an advantage of the absence of the black mask above the storage region is that the optical appearance of the storage region can also be controlled, effectively increasing the number of accurate and reproducible grey levels of the display.

For example, if 70% of the pixel 200 is required to be black, and the other 30% of the pixel is required to be white (i.e. a grey level of 70%), then rather than making the whole pixel appear black as with prior art displays, the active region (representing in this example 70% of the pixel area) can be made to appear black, and the storage region (representing in this example 30% of the pixel area) can be made to appear white. Clearly, this is particularly effective for physically large pixels where the 70% of the pixel that should be black covers the active region and where the 30% of the pixel that should be white covers the storage region. A method of using this approach to effectively increase the resolution of the display is described below in relation to FIG. 4.

The charged particles may have a different color to black, for example they may be yellow, cyan, magenta, green, red or blue, provided that they have a different appearance to the electrophoretic fluid within which they are contained.

The areas of black masking extend continuously in a direction along two opposing sides of the pixel 200, and so alignment of the black mask 27 with respect to this direction is not required. Hence, this is particularly compatible with roll-to-roll manufacturing techniques, where the stretching of a pixel substrate is difficult to control in the direction of the transport of the substrate, thereby making accurate alignment in the direction of transport of the substrate more difficult.

Alternatively, the areas of black masking 27 may be removed from the inactive areas completely to gain further cost advantages. Optionally, the black masking 27 may be extended to cover the gate region 22 of the pixel 200 to improve the contrast of the pixel. The black mask 27 may also be extended to cover the storage region of the pixel, and the manufacture of the black mask may be simplified since it can be made less dense due to the charged black particles within the storage region. Furthermore, the alignment of the black mask 27 becomes less important when the black mask is made less dense, since un-intentional intrusions of the black masking into areas over the active region will absorb less light. Since the light must pass through the black mask that is un-intentionally within the active area twice (once on incidence, once on reflection), the unwanted absorption of light reduces in proportion to the square of the reduction in black mask density.

The pixels 200 described above are passive, and do not comprise any active switching circuitry. Alternatively, the pixels 200 may be active electrophoretic pixels, and may comprise active circuitry within active circuitry regions of each pixel. For example, each pixel may comprise a Thin Film Transistor (TFT) that may be controlled to switch the voltages that are applied to the electrodes of the pixel. The active circuitry region may or may not be covered by a black mask.

The graph of FIG. 3 illustrates how the optical appearances of the storage and active regions 20 and 24 of the pixel of FIGS. 2A-2C change as the charged black particles 28 are moved from the storage region 20 to the active region 24. The charged black particle 28 distribution between the storage 20 and active 24 regions of the pixel 200 is shown along the x-axis, and the optical appearances of the storage 20 and active 24 regions are shown along on the y-axis. The further along the x-axis, the less charged black particles 28 there are within the storage region 20, and the more charged black particles 28 there are within the active region 24. The further along the y-axis, the less charged black particles there are within a region (curve 30 shows storage region 20, and curve 32 shows active region 24), and so the further from black BLK and the closer to white WHTE the region appears.

The points A, B, and C marked on the x-axis correspond to the particle distributions in situations A, B, and C as shown in FIGS. 2A, 2B, and 2C. Also marked are points Sat_Act where the active region 24 has just enough charged black particles within it to be saturated (and to appear black), and Sat_Stor where the storage region 20 has just enough charged black particles within it to be saturated (and to appear black).

The curve 30 shows the optical appearance of the storage region 20, and the curve 32 shows the optical appearance of the active region 24. As can be seen from the graph, at point A when all the charged black particles are in the storage region 20, the storage region has an optical appearance of black BLK, and the active region has an optical appearance of white WHTE.

Moving further along the x-axis, as more and more charged black particles are moved from the storage region 20 to the active region 24, the optical appearance of the active region becomes closer and closer to black BLK. At point Sat_Act, the active region becomes saturated, so that adding further charged black particles to the active region does not give a visually significant change in the optical appearance.

At point B, both the storage 20 and active 24 regions have more than enough charged black particles within them to be saturated. Hence, the optical appearance of the active region 24 can be controlled by moving between points A and B on the graph, while the optical appearance of the storage region 20 remains substantially the same (i.e. black BLK). Therefore, the charged black particles within the storage region 20, between points A and B on the graph, at least partially perform the function of a black mask. The optical appearance of the active region 24 can be set to shades of grey, for example GRY on the graph, by altering the numbers of charged black particles that are moved to the active region 24, as will be apparent to those skilled in the art.

Moving further along the x-axis, the storage region loses so many charged black particles that it de-saturates after point Sat_Stor. At point C, all of the charged black particles 28 have been moved to the active region 24, and so the storage region appears white WHTE. It may be advantageous to move this many charged black particles from the storage region in order to accurately and reproducibly set a pixel grey level or to effectively increase the resolution of the pixel, as explained in more depth in relation to FIGS. 2A-2C above and FIG. 4 below.

FIG. 4 shows a plan view of a portion of a display. The portion comprises four of the electrophoretic pixels of FIGS. 2A-2C disposed between first and second substrates (not shown for clarity). The first substrate has a white reflective coating, so that the pixels form a reflective display. Alternatively, the first substrate may be transparent, so that the pixels form a transmissive display. The second substrate is transparent over the whole of the area of each pixel, although alternatively it may be coated with black masking to obscure some of the regions (e.g. as described in relation to FIGS. 2A-2C) of the pixel from the view of a viewer. The pixels 40, 41, 42, and 43 are shown displaying an image that is intended to be black within the shape of outline 45 and white outside the shape of outline 45.

The pixels are arranged in an array of rows and columns, each row of pixels being associated with a respective row electrode RE, portions of which form the gate electrodes 23 of the pixels of the row, and each column of pixels being associated with a respective column electrode CE that is connected to the viewing electrodes 25 of the pixels of the column. Each pixel's storage electrode 21 is connected to 0V potential via electrodes 29.

The electrodes RE and 29 are obviously insulated from the electrodes CE, either by an insulating layer, or by virtue of being formed on different ones of the first and second substrates.

The row and column electrodes are driven with control signals to set the optical appearances of the pixels. Firstly, all the positively charged black particles 28 of the pixels are moved to the storage region 20 of each pixel, by setting all the column electrodes CE to +15V, and all the row electrodes RE to +10V. Then, the voltages of the column electrodes CE are lowed to 0V potential, with the charged black particles 28 being held within the storage regions 20 by the electric fields between the gate 23 and storage 21 electrodes.

Secondly, the rows of pixels are all addressed one by one, and the column electrodes CE simultaneously supply data to each pixel of the row being addressed to set the optical appearances of the pixels of the row. A row of pixels is addressed by temporarily lowering the row electrode RE of the row from +10V down to 0V. For example, for each pixel of the addressed row that is to have an optical appearance of white, the column electrode CE associated with that pixel is set to +5V, keeping the charged black particles within the storage region, and for each pixel of the addressed row that is to have an optical appearance of black, the column electrode CE associated with that pixel is set to −5V, attracting the charged black particles through the gate region 22 and into the active region 24. The number of charged black particles that move into the active region of that pixel depends on how long the pixel's gate and viewing electrodes are held at 0V and −5V respectively.

Pixels 40 and 42 are both within the outline 45, and so both have their storage and active regions saturated so that they display a black optical appearance. Pixel 43 is outside of the outline 45, and so has no charged black particles within its active area so that it displays a white optical appearance. The outline 45 crosses through pixel 41, with the active region substantially within outline 45, and the storage region substantially outside of region 45. Hence, the active region is saturated so that it has a black optical appearance, and the storage region has no charged black particles within it so that it displays a white optical appearance. Hence the resolution of the display is effectively increased beyond the pixel level, since the optical appearance of the storage regions can be controlled to display black or white whenever the active region is required to display black. For example, pixels 40 and 41 both display a black active region, however pixel 40 displays a black storage region whereas pixel 41 displays a white storage region. This enables the display of image features which would otherwise disappear when the high resolution source image (e.g. outline 45) is scaled to the display pixel resolution. With added image processing, good use could be made of the storage and active regions by independently controlling the small (storage region) pixel area and the larger (active region) pixel area.

The time required to move all of the charged black particles out of the storage region is typically shorter than the time required to move all of the charged black particles out of the active region, since the storage region has a smaller area, and so the charged black particles do not have to move so far to move out of it.

In summary, there is disclosed a display device comprising a plurality of pixels, each pixel comprising charged particles that are movable between storage and active regions of the pixel under the influence of an electric field. The number of charged particles within the active region primarily determines the optical appearance of the pixel, and the storage region is used for storing charged particles away from the active region. Each pixel comprises enough charged particles to saturate both the storage and active regions, such that moving additional charged particles to those regions does not significantly affect the optical appearances of those regions. Hence there are always enough charged particles available within the pixel to saturate the active region, and the storage region may be saturated even when the active region is saturated.

Numerous other embodiments falling within the scope of the appended claims will also be apparent to those skilled in the art. There are many different electrode arrangements and drive schemes that may be used to generate electric fields to move the charged particles between the storage and active regions of each pixel. For example, the pixel may contain an additional electrode, positioned in the active area of the pixel, to assist with the motion and the distribution of the charged particles across the active area.

The invention has been described in relation to an electrode arrangement that includes a gate electrode between the storage and active regions, although alternatively the gate electrode may not be present and the movements of the charged particles may simply be controlled by an electrode within the storage region and an electrode within the active region.

The charged particles may be of any color different to the medium in which they are contained. The charged particles may for example be colored using dyes or pigments, or they may be made from naturally colored materials such as for example carbon or titanium oxide. The charged particles may be negatively charged instead of positively charged, which would require the polarities of the drive signals discussed in the embodiments to be reversed to produce similar charged particle movements.

The invention has been described in relation to traditional electrophoretic pixels, although the invention may equally be applied to other types of moving particle pixels, such as Liquid Powder Display (LPD) pixels.

Although reference has been made to rows and columns in the description, it will be appreciated that these terms can be interchanged. For example, if the display is rotated by 90° then the rows may be considered as columns and the columns may be considered as rows. Reference signs in the claims are not to be construed so as to limit the scope of the claims.

1. A display device comprising a plurality of pixels (200), each pixel comprising:
movable charged particles (28);
an active region (24), the number of charged particles (28) that are moved into the active region determining the optical appearance of the pixel (200);
a storage region (20) for storing charged particles (28) away from the active region (24); and wherein the charged particles (28) are movable between the storage (20) and active (24) regions under the influence of an electric field; and wherein each pixel comprises a sufficient number of charged particles (28) to simultaneously saturate (Sat_Act, Sat_Stor) both the storage (20) and active (24) regions.

2. A display device according to claim 1, wherein each pixel (200) comprises a storage electrode (21) associated with the storage region (20), and a viewing electrode (25) associated with the active region (24).

3. A display device according to claim 2, wherein each pixel (200) further comprises a gate electrode (23) associated with a gate region (22) between the storage (20) and active (24) regions, and wherein the charged particles (28) are movable between the storage (20) and active (24) regions via the gate region (22).

4. A display device according to claim 3, wherein the plurality of pixels are arranged in an array of rows and columns of pixels (40, 41, 42, 43), each row of pixels associated with a respective row electrode (RE) that is connected to or forms portions of the gate electrodes (23) of the pixels of the row, and each column of pixels associated with a respective column electrode (CE) that is connected to or forms portions of the viewing electrodes (25) of the pixels of the column, and wherein the row (RE) and column (CE) electrodes are drivable with control signals to set the optical appearances of the pixels.

5. A display device according to claim 1, wherein the plurality of pixels (200) are disposed between first and second substrates, the charged particles (28) being movable lateral to the substrates between the storage (20) and active (24) regions of each pixel, and wherein the second substrate is transparent over both the storage and active regions of each pixel, such that the storage and active regions are viewable by a viewer.

6. A display device according to claim 5, wherein the second substrate is transparent over the whole of each pixel, such that the whole of each pixel is viewable by a viewer.

7. A display device according to claim 1, wherein the plurality of pixels (200) are active matrix in-plane electrophoretic pixels, and wherein each pixel comprises active circuitry within an active circuitry region of each pixel.

8. A method for driving a display device, the display device comprising at least first (40) and second (41) pixels, each pixel comprising:
movable charged particles (28);
an active region (24), the number of charged particles (28) that are moved into the active region determining the optical appearance of the pixel;
a storage region (20) for storing charged particles (28) away from the active region; and wherein the charged particles (28) are movable between the storage (20) and active (24) regions under the influence of an electric field; and wherein each pixel comprises a sufficient number of charged particles (28) to simultaneously saturate (Sat_Act, Sat_Stor) both the storage (20) and active (24) regions, the method comprising:
attracting all of the charged particles (28) of the first pixel (40) to the storage region (20) of the first pixel, thereby saturating the storage region of the first pixel;
attracting a first number of charged particles (28) from the storage region (20) of the first pixel (40) to the active region (24) of the first pixel; and wherein the first number of charged particles (28) is high enough to saturate the active region, but not so high that the storage region loses saturation.

9. The method of claim 8, further comprising:
attracting all of the charged particles (28) of the second pixel (41) to the storage region (20) of the second pixel (41), thereby saturating the storage region (20) of the second pixel (41);
attracting a second number of charged particles (28) from the storage region (20) of the second pixel (41) to the active region (24) of the second pixel (41); and
wherein the second number of charged particles (28) is high enough to saturate the active region (24) and de-saturate the storage region (20), thereby altering the optical appearance of the storage region (20).
